(19) United States
(12) Patent Application Publication
(10) Pub. No.: US 2020/0215786 A1
(43) Pub. Date: Jul. 9, 2020

(54) INSULATIVE CONSTRUCTS WITH SELECTIVE VENTING

(71) Applicant: The North Face Apparel Corp., Wilmington, DE (US)

(72) Inventors: Jeffrey Allen Dorton, Dublin, CA (US); Jason Israel, Greenwood Village, CO (US)

(21) Appl. No.: 16/631,350

(22) PCT Filed: Jul. 13, 2018
(86) PCT No.: PCT/US2018/041989

§ 371 Date: Jan. 15, 2020

Related U.S. Application Data
(60) Provisional application No. 62/536,442, filed on Jul. 24, 2017.

(51) Int. Cl. B32B 3/26; B32B 5/14; B32B 5/02; B32B 5/22; A41D 31/02; A41D 27/28

(52) U.S. Cl. CPC B32B 3/266; B32B 5/142; B32B 5/022; B32B 5/22; A41D 31/02; B32B 2437/00; B32B 2307/304; B32B 2307/51; B32B 2307/718; B32B 2307/72; A41D 27/28

(57) ABSTRACT

A construct of selectively ventable insulation. The construct includes a substrate layer of a cohesive, bulky web of entangled fibers, with the web material defining a first side and an opposing second side of the substrate layer. The web material has an undulated form based on lapping of the web material. A covering layer is disposed adjacent to and coextensively over the first side of the substrate layer. A plurality of slits are formed in the covering layer. The slitted covering layer is configured so that when it is in a first condition, the slits are closed, and when in a relatively tensioned second condition, the slits become open perforations through the covering layer, thereby allowing venting of air or other fluid from a side of the covering layer that is adjacent the first side of the substrate layer. In another embodiment, the construct includes a substrate layer of a cohesive, bulky web of entangled fibers, with the web material defining a first side and an opposing second side of the substrate layer. The substrate layer may or may not have undulations. A plurality of slits are formed in the substrate layer so that when it is in a first condition the slits are closed, and when in a relatively tensioned second condition, the slits become open perforations through the substrate layer, thereby allowing venting of air or other fluid from the first side of the substrate layer to its second side.

### BACKGROUND

The inventive subject matter is generally directed to selectively ventable constructs having batt insulation. They are particularly suited for use in outdoor apparel, other bodywear, and other outdoor gear.

Batt insulation material, which is a non-woven textile product, are long known in the apparel industry for use as interlayers in garments, footwear, headwear, gloves, sleeping bags and other such applications. Contemporarily, batt insulation includes those based on natural fibers, such as wool, and synthetic fibers based on polymers. The fibers may be solid or hollow core. Polyester fiberfill filling material is one example of a synthetic fiber. It has become well-accepted as a reasonably inexpensive filling and/or insulating material for filled articles, such as apparel, e.g., parkas, footwear, sleeping bags, furnishing materials, including bedding materials, such as mattress pads, quilts, comforters, pillows, etc.

Fiberfill materials, such as polyester and other synthetic fill consist of fibers that are provided in the form of continuous bonded batts. Typically, bonded batts have been made from webs of parallelized (staple) fiber that preferably consist of a blend of binder fibers and filling fibers. The batts have uniform consistency that generally does not change during use. Accordingly, when used as insulation in garments, for example, the insulation does not vary depending on how actively the garment is being used. The ventability or breathability remains the same even during vigorous use by a person wearing the garment. This can lead to excessive heating and/or moisture build-up in the garment.

Another disadvantage of bonded batt materials is that that they are not sufficiently strong or resilient for active use. Overtime the bonded fibers can separate, leading to thinned areas that provide decreased heat retention.

For example, U.S. Pat. No. 5,804,021, discloses batt materials with a slitted covering fabric. In theory, the slitted covering could provide venting. However, it does not disclose a combination of slitted covering over an insulative batt layer that is configured to provide venting and breathability, while remaining durable and resilient over repeated cycles of use. This is not surprising given that the patent is directed to disposable end products such as diapers, incontinence garments, sanitary napkins, bandages and wipers. There is no need for the intended items to stay warm, dry, durable and resilient over repeated cycles of use.

### SUMMARY

The inventive subject matter addresses the foregoing and other needs. In one possible embodiment, the inventive subject matter is directed to a construct of selectively ventable insulation. The construct includes a substrate layer of a cohesive, bulky web of entangled fibers, with the web material defining a first side and an opposing second side of the substrate layer. In this embodiment, the web material has an undulated form based on lapping of the web material. A covering layer is disposed adjacent to and coextensively over the first side of the substrate layer. A plurality of slits are formed in the covering layer. The slitted covering layer is configured so that when it is in a first condition, the slits are closed, and when in a relatively tensioned second condition, the slits become open perforations through the covering layer, thereby allowing venting of air or other fluid from a side of the covering layer that is adjacent the first side of the substrate layer.

In the foregoing embodiment, a plurality of slits may be formed in the substrate layer, the substrate layer being configured so that when it is in a first condition the slits are closed, and when in a relatively tensioned second condition, the slits become open perforations through the substrate layer, thereby allowing venting of air or other fluid from the first side of the substrate layer to its second side.

In another possible embodiment, the inventive subject matter is directed to a construct of selectively ventable insulation. The construct includes a substrate layer of a cohesive, bulky web of entangled fibers, with the web material defining a first side and an opposing second side of the substrate layer. A covering layer is disposed adjacent to and coextensively over the first side of the substrate layer. A plurality of slits are formed in the substrate layer. The slitted substrate layer is configured so that when it is in a first condition the slits are closed, and when in a relatively tensioned second condition, the slits become open perforations through the substrate layer, thereby allowing venting of air or other fluid from the first side of the substrate layer to its second side.

In the foregoing embodiment, the covering layer may be configured with a plurality of slits such that when the covering layer is in a first condition, the slits are closed, and when in a relatively tensioned second condition, the slits become open perforations through the covering layer thereby allowing venting of air, vapor or other-fluid from a side of the covering layer that is adjacent the first side of the substrate layer.

In any embodiment, a plurality of slits of the covering layer may align with a plurality of slits of the substrate layer. In any embodiment, the covering layer may be a nonwoven, drapable material in the nature of a scrim. In any embodiment, the covering layer may have an open mesh structure.

In any embodiment, a second covering layer may be disposed adjacent to and coextensively over the second side of the substrate layer. In any such embodiment, the second covering layer may be configured with a plurality of slits such that when the second covering layer is in a first condition, the slits are closed, and when in a relatively tensioned second condition, the slits become open perforations through the covering layer thereby allowing venting of air or other fluid from a side of the covering layer that is adjacent the second side of the substrate layer.

In any embodiment, the substrate layer and/or the covering layer may be a laminate of multiple plies of insulation material or covering layer material. The construct of any claim herein wherein at least one layer of the construct is elastic. In any embodiment, any layer in the construct may be an elastic layer. In any embodiment, the elastic layer may be at least one of the layers having the slits. The inventive subject matter is also directed to methods of making a construct of selectively ventable insulation. In one possible embodiment, the method includes the steps of: providing a substrate layer comprising a cohesive, bulky web of entangled fibers, with the web material defining a first side and an opposing second side of the substrate layer, with web material therebetween having an undulated form based on lapping of the web material; providing a covering layer disposed adjacent to and coextensively over the first side of the substrate layer, a plurality of slits formed in the covering layer, assembling the covering layer adjacent to and coextensively over the first side of the substrate layer; and wherein the covering layer is assembled and configured so that when it is in a first condition, the slits are closed, and when in a relatively tensioned second condition, the slits become open perforations through the covering layer, thereby allowing venting of air or other fluid from a side of the covering layer that is adjacent the first side of the substrate layer.

In another possible embodiment, the method includes the steps of providing a substrate layer comprising a cohesive, bulky web of entangled fibers, with the web material defining a first side and an opposing second side of the substrate layer a plurality of slits being formed in the substrate layer; providing a covering layer, assembling the covering layer adjacent to and coextensively over the first side of the substrate layer; and wherein the substrate layer is assembled and configured so that when it is in a first condition the slits are closed, and when in a relatively tensioned second condition, the slits become open perforations through the substrate layer, thereby allowing venting of air or other fluid from the first side of the substrate layer to its second side.

In another possible embodiment, the inventive subject matter is directed to methods of making articles incorporating the inventive concepts. Representative articles include articles of apparel, footwear, headwear, gloves, sleeping bag having a panel comprising assembling according to any of the other claims herein with one or more other portions of the article. In any such article, the construct may be an interlayer disposed between other layers of the article. In any such article, the construct may be selectively mapped to an area of the article that needs relatively more venting or breathability than an adjacent area.

Other embodiments are contemplated in the detailed description below and in the appended Figures, and in the claims, as originally written or amended, and the claims as such being incorporated by reference into this Summary. Persons skilled in the art can appreciate such other embodiments and features from the following detailed description in conjunction with the drawings.

### BRIEF DESCRIPTION OF THE DRAWINGS

The appended figures show embodiments according to the inventive subject matter, unless noted as showing prior art.

FIG. 1 is a perspective view of a slit construct in an unstretched first condition.

FIG. 2 is a top plan view of the slit construct of FIG. 1 stretched along line B-B.

FIG. 3 is a top plan view of another possible slit construct.

FIG. 4 shows the slit construct of FIG. 3 stretched along line B-B.

FIG. 5 is a top plan view of another possible slit construct.

FIG. 6 shows the slit construct of FIG. 5 stretched along lines A-A and B-B.

FIG. 7 is a perspective view of yet another slit construct.

FIG. 8 is a schematic side view of a process for forming a slit construct.

FIG. 9 is a schematic side view of another process for forming a slit construct.

FIG. 10 shows a side sectional view of still another slit construct.

FIG. 11 is a schematic perspective view of a process for forming the substrate layer used in the slit construct of FIG. 10.

FIG. 12 shows a representative article incorporating an inventive construct.

FIG. 13 shows a representative article incorporating an inventive construct.

FIG. 14 shows another embodiment of a slit construct in stretched and unstretched condition.

FIGS. 15A-15C are photographs showing details of layers used in a construct like that of FIG. 10.

FIG. 16 is a schematic perspective view of another process for forming a substrate layer.

FIG. 17 is a photograph showing a cross-section of a construct formed by the process shown in FIG. 16.

FIG. 18 is a schematic perspective view of still another process for forming a substrate layer.

FIG. 19 is a photograph showing a cross-section of a construct formed by the process shown in FIG. 18.

### DETAILED DESCRIPTION

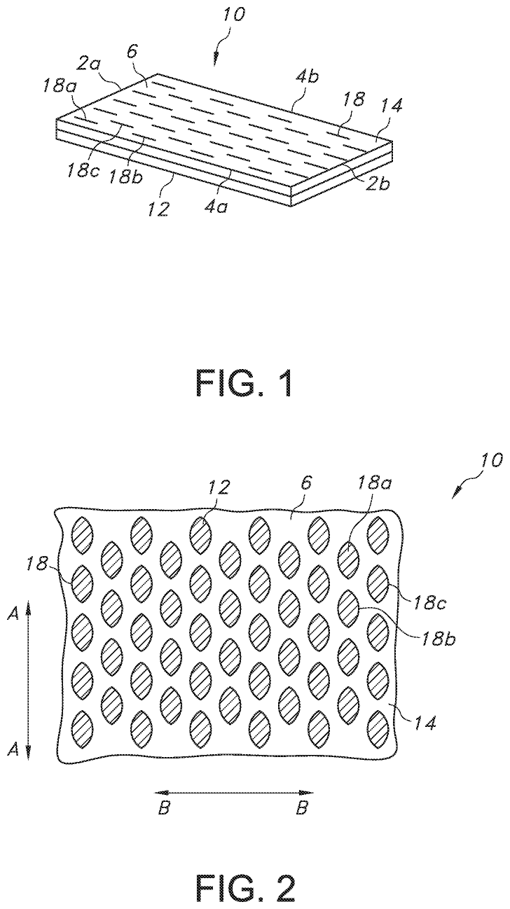

Representative embodiments according to the inventive subject matter are shown in FIGS. 1-19, wherein the same or generally similar features share common reference numerals.

The inventive subject matter is generally directed to pliable constructs 10, 110 that provide thermal insulation but with selective venting or breathability under certain conditions. As used herein, “venting” or “breathability” are generally synonymous terms that mean facilitation of air or fluid transport from one side of a surface to an opposite side, although “breathability” often implies transport of moisture laden air or vapor.

The inventive subject matter is also directed to articles incorporating the constructs, such as representative articles 200, 300. The constructs are particularly suited for use as interlayers in various personal use articles, such as apparel, footwear, headwear, gloves, sleeping bags, and other such applications. According to the inventive subject matter, the constructs are formed at least in part from an assembly of a batt material 12, 112 and a covering layer 14, 16. The batt materials are particularly those suitable as thermal insulation. Generally, and as contemplated herein, such batt materials may be characterized as a bulky web of entangled fibers. They are typically provided in sheet form but may have non-planar, three dimensional forms as well. For example, they may be provided in forms that follow and cup contours of a body, such as the head, shoulder, elbows, knees, etc. The batt materials would typically be pliable or drapable materials when used in personal use products such as apparel.

The covering layer 14, 16 is a layer that is disposed adjacent to and coextensively over the batt material 10, 110, which may also be referred to herein as a substrate layer insofar as it is supporting one or more covering layers. The covering layer is a thinner layer that may serve to provide structural support and strength to the web of entangled fibers forming the substrate layer; venting or breathability; durability or protection; and/or a desired aesthetic. The covering layer is typically much thinner than the substrate layer. For example, the substrate layer may be at least 1.0, 1.5, 2, 4, 5, 7, 9, 10, 20, 50, 100 times thicker than the covering layer. Likewise, the covering layer is typically much lighter than the substrate layer. For example, the substrate layer may be at least 1.0, 1.5, 2, 4, 5, 7, 9, 10, 20, 50, 100, 200, 300, 400, 500 times heavier than the covering layer in terms of grams per square meter.

In the various possible embodiments of the inventive subject matter, the constructs 10, 110 provide selective venting by use of slits 18 that selectively open to full perforations through a material layer under active conditions when venting or breathability is needed. The slits may be formed in the substrate layer and/or the covering layer. A slit is a set of one or more abutting edges in a layer that can spread open to form an aperture. As used herein, a perforation is when such an aperture penetrates from one side of a layer to the other, opposing side so that there is a through hole. A given construct layer may be configured with slits so that when it is in a first condition, the slits are closed, and when in a relatively tensioned second condition, the slits open to full perforations, thereby allowing venting of air, moisture, or other fluid from one side of a layer to another.

Any given slitted layer may be elastic to facilitate the opening/closing of the slits. Taking an article of apparel or other bodywear as an example, an inactive user may not stress the covering layer enough to open the slits. In a cold environment, this is beneficial so that the insulative construct will help retain body heat. However, once the user is active, venting and breathability may be needed. Vigorous movement of arms, legs, or other body parts will place sections of a slitted layer that are on opposite sides of the slits under tension. Sufficient tension will cause the slits to open to perforations. Heat and/or moisture that has built up on one side of the slitted layer will vent though the perforations. The perforations also allow exterior air to pass through the openings to cool the user's body. Once the user becomes less active, the perforations close so that heat is retained.

Principles of the inventive subject matter will now be illustrated with respect to certain possible, non-limiting embodiments shown in the Figures. FIG. 1 shows an insulative construct 10 according to the inventive subject matter. The construct may be made of one or more layers of elastic, fibrous nonwoven sheet or ply material. For example, the construct may include a nonwoven batt layer 12, which may also be referred to herein as a “substrate layer”, and at least a covering layer 14. The covering layer is typically thin relative to substrate layer 14, serving to benefit the substrate layer. For example, the covering layer may strengthen, protect, and/or aesthetically benefit the substrate layer. It may also benefit the substrate layer by serving as an interface layer that is intermediate the substrate layer and another layer, facilitating the attachment of the substrate layer to the other layer.

Construct 10, or one or more of the layers 12, 14, 16, and any other layer contemplated herein, may be an elastic construct or layer. A material, layer, or construct is “elastic” or has “elastic properties” if it can be stretched or extended from a first and generally relaxed (no external tensional force) length to a second or expanded length. As used herein, an elastic layer is one which can stretch at least two times the first length and then, upon release of the stretching forces, retracts to a third length which is no greater than 110 percent of the first length. Or, stated differently, the third length is no greater than 1.1 times the first length. Thus, as an example, a material or layer would be elastic if it had an initial length of 100 centimeters, could be stretched to a length of at least 200 centimeters and then, upon release of the stretching forces, retracted to a length that was no greater than 110 centimeters.

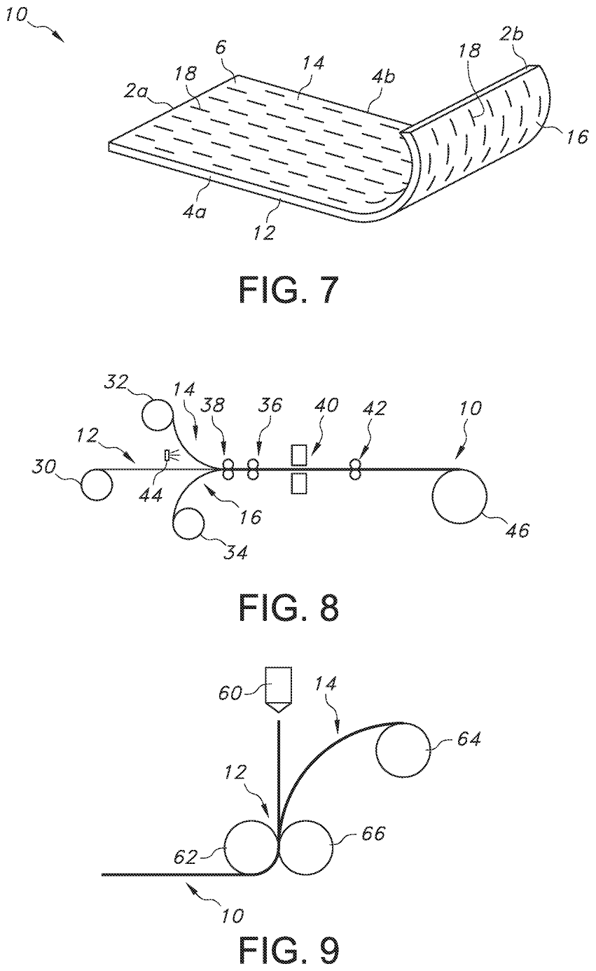

If desired, additional layers may be incorporated within construct 10. For example, a second fibrous nonwoven covering layer 16 may be disposed on a surface of the nonwoven batt layer 12, which second covering layer is opposed to the first covering layer 14. See FIG. 7. For purposes of clarity, the term “layer” will generally refer to a single piece of material but the same term should also be construed to mean multiple pieces or plies of material which, laminated together, form one or more of the “layers” described herein.

The nonwoven batt layer 12, 112 may be made from any one or more natural or synthetic fibers that are formed into a cohesive, bulky web of entangled fibers. The substrate layer 12 may also be a multilayer material in that it may include two or more individual coherent webs and/or films. The layer has a thickness, bulkiness, and/or other attributes so that it may serve as thermal insulation in outdoor gear and garments. The insulative properties may vary, depending on a specific end use. For example, a ski or mountaineering parka may have greater bulk and loft than a jacket intended for trail running. In some embodiments, the nonwoven batt layer 12 is elastic in at least one direction. In some embodiments, it may be desirable to use materials that are elastic in two or more directions.

Batt insulation materials suitable for use as a substrate layer 12, 112 are well known. They include polyester fiberfill materials. For example, polyester fiberfill of solid or hollow or other special fibers are available products of the 3M Company (St. Paul, Minn.) One such product is called “Thinsulate™.” Generally, polyester fiberfill is made from crimped polyester staple fiber and is used in the form of quilted batts. Usually, batt bulk and bulk durability are maximized to increase the amount of thermal insulation. Hollow polyester fibers have found widespread use in such fiberfill batts because of the increased bulk they offer, as compared to solid fibers. In certain fiberfill materials such as Hollowfil® II™, a product of E. I. du Pont de Nemours and Company (Wilmington, Del.), the polyester fibers are coated with a wash-resistant silicone slickener to provide additional bulk stability and fluffability.

For fiber processability and in-use bulk, slickened and non-slickened fiberfill fibers for use in garments have usually been in the range of 5 to 6 denier (5.6 to 6.7 dtex). A special fiberfill, made from a blend of slickened and non-slickened 1.5-denier polyester staple fibers and crimped polyester staple fiber having a melting point below that of the other polyester fibers, in the form of a needle-punched, heat-bonded batt, is reported to exhibit excellent thermal insulation and tactile aesthetic properties. Such fiberfill batts are also discussed in U.S. Pat. No. 4,304,817. Thinsulate™ is an insulating material in the form of a thin, relatively dense, batt of polyolefin microfibers, or of the microfibers in mixture with high denier polyester fibers. The high denier polyester fibers are present in the Thinsulate™ batts to increase the low bulk and bulk recovery provided to the batt by the microfibers alone. For use in winter sports outerwear garments, these various insulating materials are often combined with a layer of film of porous poly(tetrafluoroethylene) polymer of the type disclosed in U.S. Pat. No. 4,187,390.

Though not related specifically to apparel insulating interlayers, a wide variety of spunlaced nonwoven fabrics are known in the art. For example, British Pat. No. 1,063,252 and U.S. Pat. Nos. 3,493,462, 3,508,308 and 3,560,326 disclose stable, nonapertured, jet-tracked, spunlaced nonwoven fabrics of hydraulically entangled polyester fibers and filaments. Usually, the spunlaced fabrics are produced by subjecting a fibrous batt to closely spaced, high energy flux, columnar jets of water. In commercial operations, the jets are usually arranged in rows in which the number of jets per centimeter is in the range of 10 to 25. The use of widely spaced jets also has been disclosed. For example, in British Pat. No. 1,063,252, Example I describes the hydraulic stitching of a batt of polyester fibers in “quilt-like” fashion to form “seams” that are spaced ¾-inch (1.9-cm) apart in the batt and Example II describes the steaming of the stitched batt. However, neither example records detailed characteristics of the stitched batt. Applicant has found that such stitched batts are generally very weak and difficult to handle.

Various fibrous layers, such as batts, webs, scrims, sheets and papers, can be combined by means of hydraulic entanglement techniques into spunlaced nonwoven fabrics. For example, Canadian Pat. No. 841,938 discloses “laminating,” by means of hydraulic entanglement, batts of staple rayon fibers, or sheets of paper (i.e., wood pulp fibers) to sheets of continuous polyester filaments. At least 10 jets per inch (4 per cm) and preferably 30 to 50 per inch (12 to 20 cm) are suggested for forming the spunlaced “laminates.”

Staple fiber blends which are suitable for use in the fabric of the inventive subject matter can be prepared by any of several known methods. For example, batts may be prepared by carding and cross-lapping, by Rando-Webber techniques or by the air-laydown methods described in U.S. Pat. No. 3,797,074. Usually, the batts have an area weight in the range of 100 to 250 g/m2. For lighter weight fabrics, batts of no heavier than 150 g/m2 are preferred.

Suitable staple fiber batts for use in the invention may be prepared from, for example, blends of light and heavy, crimped, polyester staple fibers. The light fibers may have a dtex in the range of 1 to 90 and amount to 40 to 85% by weight of the batt. In certain possible embodiments the light fibers amount to at least 50% by weight of the batt. In certain possible embodiments, the heavy fibers have a dtex which is at least two times, but no greater than 15 times that of the light fiber. In some possible embodiments, the dtex of the heavy fibers is at least four times that of the light fibers. The foregoing ranges and values are exemplary and other ranges and values may also be suitable, as will be appreciated by persons skilled in the art.

In some embodiments, the crimped polyester staple fibers of the batt have crimp levels of 2 to 5 crimps/cm, but higher or lower crimp levels also can be suitable. The staple fiber length is usually in the range of 1 to 6 cm, though shorter or longer fibers also can be satisfactory. The fibers may be solid or hollow and of substantially any cross-section.

In addition to the light and heavy staple fibers, the batt material optionally may contain binder fibers. Upon heat treatment at temperatures above their, melting point, the binder fibers lose their identity as fibers by coalescing on the surfaces or at the cross-overs of the other fibers to bond the batt. Bonding, though not necessary, enhances the dimensional stability of the staple fiber batt.

According to the inventive subject matter, the above-described blends of crimped, polyester staple fibers impart appropriate density, thickness, resilience, hand and insulating characteristics to the composite nonwoven fabric. Within the limits prescribed for the staple fiber batts, following general effects, batt parameters may be controlled as follows: Increase in the amount of heavy fibers or their denier usually results in composite fabrics having greater resilience and bulk. Increased fiber crimp enhances softness. Increases in the amount of hollow fiber increases bulk, decreases density and improves thermal resistance. Any decreases in batt density generally increase the thermal resistance of the composite fabric.

The basis weight of a fabric used as substrate layer 12 may range from about 5 to about 250 grams per square meter. The basis weight can be varied, however, to provide desired properties including recovery and barrier properties. In some possible embodiments, the basis weight of the elastomeric substrate may range from about 25 to about 200 grams per square meter. Even more particularly, the basis weight of the elastomeric fabric may range from about 40 to about 150 grams per square meter.

Attached to the substrate layer 12 is at least a first fibrous web covering layer 14 and/or 16. The basis weight of the covering layer 14 will depend upon the end use. Generally, elastomeric nonwoven, bonded, carded webs and spunbond webs are suitable covering layers. Woven and/or knit layers, which tend to be heavier and more expensive than nonwoven materials, may also be suitable in certain applications, for example, where weight and/or cost of the material is of less significance with respect to other criteria. These constructions may be formed with elasticity that is suitable for certain embodiments.

One form of covering layer that is particularly suitable for use with insulative batts is a “scrim” sheet. Although there may be exceptions, the basic difference between a woven fabric and a nonwoven scrim is that weaving requires a classic under-and-over interlacing, whereas in nonwoven scrims the yarns lay on top of each other and are held together chemically. One of the most significant differences is the “straightness” of yarns in nonwoven scrims. In the nonwoven scrim, yarn properties are translated more directly into fabric properties since the “uncrimping”” elongation and yarn/yarn friction associated with woven geometry are largely absent. Naturally, bias behavior is also very different since yarns in nonwoven scrims are usually locked in place and can't collapse in the way a classic woven lattice does.

The processes used to form the fibrous nonwoven web covering layers 14, 16 include those that result in a material which, as further described below, has the necessary range of physical properties. Suitable processes include, but are not limited to airlaying, spunbonding, and bonded carded web formation processes. Spunbond nonwoven webs are made from fibers which are formed by extruding a molten thermoplastic material as filaments from a plurality of fine capillaries in a spinnerette with the diameter of the extruded filaments then being rapidly reduced, for example, by non-eductive or eductive fluid-drawing or other well-known spunbonding mechanisms. The production of spunbonded nonwoven webs is illustrated in patents, such as Appel, et al., U.S. Pat. No. 4,340,563; Dorschner et al., U.S. Pat. No. 3,692,618; Kinney, U.S. Pat. Nos. 3,338,992 and 3,341,394; Levy, U.S. Pat. No. 3,276,944; Peterson, U.S. Pat. No. 3,502,538; Hartman, U.S. Pat. No. 3,502,763 and Dodo et al., U.S. Pat. No. 3,542,615.

The covering layers 14, 16 also may be made from bonded, carded webs. Bonded carded webs are made from staple fibers which are usually purchased in bales. The bales are placed in a picker which separates the fibers. Next, the fibers are sent through a combing or carding unit which further breaks apart and aligns the staple fibers in the machine direction so as to form a generally machine direction-oriented fibrous nonwoven web. Once the web has been formed, it is then bonded by one or more of several bonding methods. One bonding method is powder bonding wherein a powdered adhesive is distributed through the web and then activated, usually by heating the web and adhesive with hot air. Another bonding method is pattern bonding wherein heated calender rolls or ultrasonic bonding equipment are used to bond the fibers together, usually in a localized bond pattern though the web can be bonded across its entire surface if so desired. One of suitable method, when using bicomponent staple fibers, is to use a through-air bonder such as is described above with respect to the bicomponent spunbond web formation process.

Airlaying is another well-known process by which fibrous nonwoven webs according to the inventive subject matter can be made. In the airlaying process, bundles of small fibers usually having lengths ranging between about 6 and about 19 millimeters are separated and entrained in an air supply and then deposited onto a forming screen, oftentimes with the assistance of a vacuum supply. The randomly deposited fibers are then bonded to one another using, for example, hot air or a spray adhesive.

The covering layer 14, 16 may be made of various materials having some or all of the properties discussed above. Examples of materials may include, without limitation, thermoplastic urethane (TPU), thermoplastic polyester elastomer (TPEE), polyester, polyester ester (COPE), styrene ethylbutylene styrene (SEBS), MPV, polyether block amide (PEBA), elastane, polyurethane (PU), or combinations thereof. Knit or woven constructions with elasticity may be suitable, as noted.

A process for forming a laminate 10 according to the inventive subject matter is shown in FIG. 8. A layer of nonwoven batt layer 12 is unrolled from a supply roll 30 and fed through a pair of drive and compaction rolls 36. Alternatively, the nonwoven batt layer 12 may be formed directly in-line. Next, a supply of a first fibrous nonwoven web covering layer 14 is unrolled from a supply roll 32 or it also may be formed in-line. Before the substrate layer 12 and/or covering layer 14 is passed through the drive rolls 36, slitting may be provided. When provided, slits 18 may perforate just substrate layer 12, just covering layer 14, 16, or through the entire assembly of covering layer(s) and substrate layer, as discussed in more detail elsewhere herein. The following discussion, while focusing on covering layer 14, generally applies to any given layer where slits are desired. Slits may be formed in various manners, including by processes that provide mechanical perforations, such as punching, laser cutting, and chemical ablation.

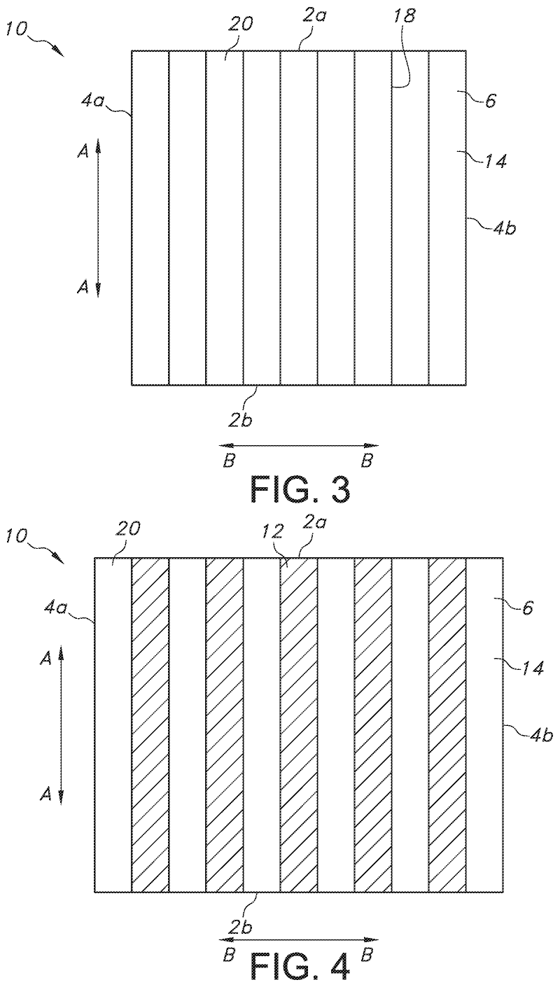

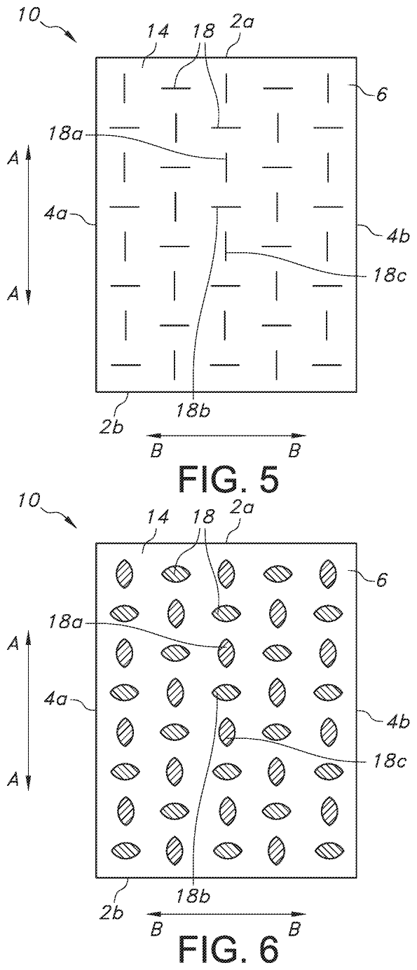

The slits 18 may be discontinuous such as are shown in FIGS. 1, 5, and 7 or continuous such as are shown in FIG. 3. A slit 18 is “discontinuous” if, as shown, for example, in FIGS. 1, 5 and 7, the length of the slit is insufficient to extend continuously from one longitudinal edge 2a or transverse edge 4a of the covering layer 14 to an opposing longitudinal edge 2b or transverse edge 4b, respectively. More specifically, as shown in FIGS. 1 and 7, a set of individual discontinuous slits 18 may be placed in a series or plurality of generally parallel rows extending from one edge of the covering layer 14 to an opposing edge. For example, slits 18a and 18b are placed in one row, while slit 18c is placed in a different row oriented generally parallel to the row including slits 18a and 18b. Each row of individual discontinuous slits 18 includes a plurality of such slits that can be regularly spaced from one covering layer edge to the opposing covering layer edge to impart extensibility to the nonwoven covering layer 14 in a direction generally perpendicular to the direction of the slits. Due to the placement of individual discontinuous slits between the edges of the covering layer 14, the resulting laminate 10 exhibits extensibility or elastic properties not just along the edges 2a and 2b 4a and 4b, but across exposed surface 6 of the laminate 10 (see, e.g., FIG. 2). As shown in FIG. 5, a first set of individual discontinuous slits may be placed in a first series or plurality of generally parallel rows extending from one longitudinal edge 2a of the covering layer 14 to opposing longitudinal edge 2b, and a second set of individual discontinuous slits may be placed in a second series or plurality of generally parallel rows extending from one transverse edge 4a of the covering layer 14 to opposing transverse edge 4b, wherein the first and second sets of discontinuous slits are generally perpendicular in orientation. Alternatively, a slit is “continuous” if, as shown, for example, in FIG. 3, the length of the slit 18 is sufficient to extend continuously from one longitudinal edge 2a of the covering layer 14 to an opposing longitudinal edge 2b. Although not shown in the Figures, such continuous slits 18 could be oriented to extend continuously from one transverse edge 4a of the covering layer 14 to an opposing transverse edge 4b.

Slits 18 may be pre-formed or formed directly in-line as by a slitting roll or other means 38. It is possible to create the slits after the formation of the laminate too. A particularly advantageous slit pattern is one wherein the slits are formed in what is generally referred to as an “overlapping brick pattern.” In this pattern the slits in one row overlap the gaps between the slits in an adjacent row. This pattern provides good expansion of the covering layer and the overall laminate.

Once the two layers 12 and 14 (and/or 16) have been brought together they may be attached to one another. Attachment can be by any suitable means such as heat bonding, ultrasonic bonding, adhesive bonding or other suitable means. The degree of attachment should be sufficient to maintain attachment during subsequent use of the laminate but not to such a degree as to prevent the slits 18 from opening in the manner shown in FIGS. 2, 4 and 6.

As shown in FIG. 8, the attachment means in the process may include a heating apparatus 40 for providing hot air and a pair of compaction rolls 42. The surface of the compaction rolls may be smooth and/or patterned. In addition, they may be heated in which case the heating apparatus 40 may be deleted. If a spray adhesive is used, the delivery system 44 must be positioned such that the adhesive is applied to the interior surfaces of the substrate layer 12 and first covering layer 14. Other means for attaching the layers together include but are not limited to ultrasonic bonding, infrared bonding, radio frequency bonding, powdered adhesive bonding, hydroentangling, and mechanical entangling such as needling and direct forming of one layer onto another. Once the two layers 12 and 14 have been attached to one another, the resultant laminate 10 may be wound up on a take-up roll 46 or the laminate 10 may remain in-line for further processing.

Another process for forming a laminate according to the inventive subject matter is shown in FIG. 9. In this process, substrate layer 12 may be an extruded elastic film emitted from a film die 60. The molten polymer is brought in contact with a chill roll 62 to help solidify the molten polymer. At the same time, a supply 64 of nonwoven covering layer material 14 is brought into contact with the still tacky elastic film material 12 between the chill roll 62 and a second roll 66, such as an 85 Shore A rubber roll, which may or may not be chilled. By “chilled” it is meant that the roll 62 or 66 has a temperature which is less than the melting point of the film polymer. Because of the elastic properties in the film layer 12, a laminate 10 is formed which will at least have elastic properties in the cross-direction (CD), which is a long line B-B in FIG. 2. Slits may be formed in one or both layers using techniques described above.

As noted, the substrate layer 12 may have elastic properties in only one direction or in multiple directions. If the substrate layer 12 is only elastic in one direction, then at least a portion of the slits 18 in the covering layer 14 should be generally perpendicular to the direction of elasticity in the nonwoven batt layer 12. By “generally perpendicular” it is meant that the angle between the longitudinal axis of the chosen slit or slits and the direction of elasticity is between 60° and 120°. In addition, when it is said that “at least a portion of the plurality of slits must be generally perpendicular to the direction of elasticity or stretch”, it is meant that there must be enough of the described slits which are generally perpendicular such that the overall laminate has “elastic properties”. Thus, in FIG. 2, if the nonwoven batt layer 12 is only elastic in one direction, that direction must be generally along line B-B and not A-A. By placing the direction of elasticity along line B-B, the slits 18 are generally perpendicular to the direction of elasticity. As a result, when stretching forces are applied along line B-B, the slits 18 will open up and permit the laminate 10 to expand in the same direction. Placing the direction of elasticity of substrate 12 along line A-A would not make this possible.

The same rationale also applies to the laminate shown in FIGS. 3 and 4. Here again if the nonwoven batt layer 12 is only elastic in one direction, that direction must be generally aligned with line B-B and not A-A.

In FIG. 5, the substrate layer 14 has slits in two directions. One set of slits 18 are generally perpendicular to line A-A while the other set of slits 18 are generally perpendicular to line B-B. This type of slit pattern is particularly advantageous when the nonwoven batt layer 12 is elastic in at least two directions as, for example, along lines A-A and B-B. As can be seen from FIG. 6, in this configuration, the resultant laminate 10 can exhibit “elastic properties” in two directions.

The construct 10 produced according to the inventive subject matter will generally have a basis weight less than about 700 grams per square meter and generally less than 300 grams per square meter and may even less than 150 grams per square meter, depending on intended uses, as will be appreciated by persons skilled in the art.

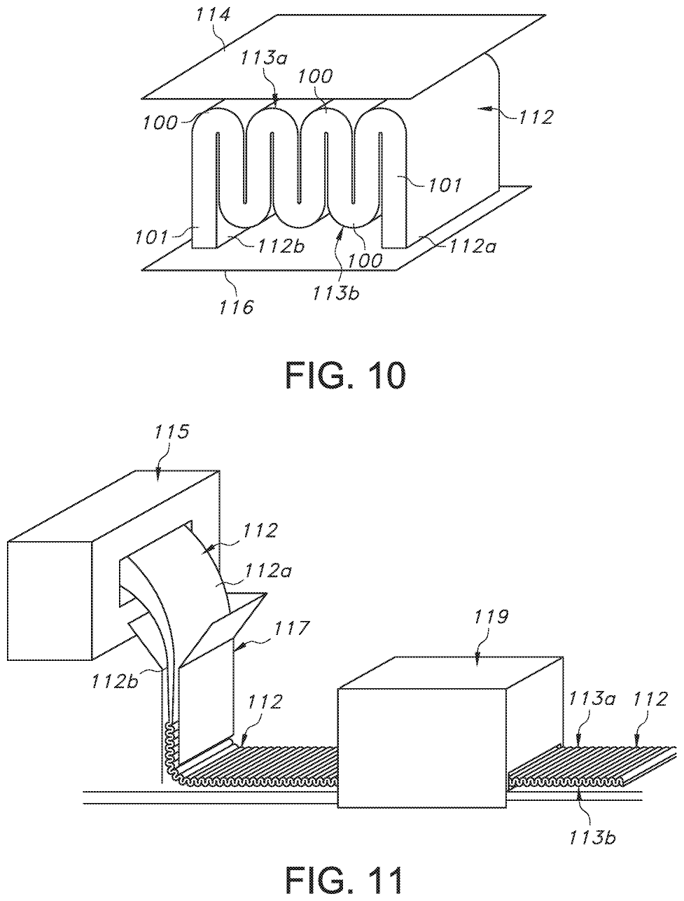

Looking now particularly at construct 110 of FIG. 10, it is a thermally insulative laminate that provides selective venting and breathability. In the construct, substrate layer 112 is a cohesive, bulky web of entangled fibers, with the web material defining a first side 113a and an opposing second side 113b of the substrate layer. In this embodiment, but not necessarily in all embodiments, the web material has an undulated form based on lapping of the web material during manufacturing. The undulated form provides greater structural integrity and durability to the substrate layer. In conventional sheets of web material without undulations, the web can break down under repeated cycles of stress that may occur from washing/drying or active use. In such conventional sheet materials, the web and fibers are primarily oriented in a horizontal plane. The undulated form also orients the web and its fibers in a vertical plane. This strengthens the web from forces acting in both planes, both compressive and tensional. In the vertical plane, the undulations act like structural corrugations. In the horizontal plane, the undulations act like an accordion that can be pulled and pushed. The undulations can be characterized as positive and negative peaks 100 which are adjacent each other and compacted together to define first side (top surface) 113a and the opposing second side (bottom surface) 13b of substrate layer 112. Sidewalls 101 converge into the peaks and are oriented orthogonally, or perhaps transversely, to the sides 113a, 113b of the substrate layer. The sidewalls can lead to rounded peaks (shown), triangular peaks, or other converging shapes. The shapes of the positive and negative peaks 100 need not be mirror images of one another however. Further, the compactness of the sidewalls and peaks may be varied to provide different attributes. For example, more peaks per square centimeter will result in a denser, stronger structure. However, the denser structure may decrease venting or breathability. To hold the substrate layer in the undulated form and to further increase strength and durability, the adjacent sidewalls 101 may be bonded together using fusible fibers or chemical bonding agents. In the case of apparel and other bodywear, the undulations in the web provide may be an accordion-like structure that may be expanded or contracted, depending on motion of the body and level of activity. As the undulated form is stretched, the web material becomes less dense and may reduce in thickness, which facilitates dissipation of heat and moisture that may build up on one side of the web. More activity will lead to more cycles of expansion, thereby higher activity levels selectively facilitate heat dissipation.

Only a few undulations are shown in FIG. 10 for clarity and brevity. In practice, the undulated substrate 110 may be continuous from one edge of the cover layer to the other, where one edge of the substrate may end in a positive peak and an opposing edge may end in a negative peak, or may end part way up a sidewall.

The cover layers 114, 116 may have slits in one or both layers, or may not have any slits in either layer.

In another embodiment, the construct 110 shown in FIG. 10, may be a waterproof breathable insulated construct. As a waterproof breathable insulated construct, one or more of the cover layers 114, 116 may be made of an elastic or inelastic waterproof breathable membrane material. The waterproof breathable membrane may be, for example, a polyurethane (PU) material, a microporous PU material, a polytetrafluoroethylene (PTFE)material, a non-swelling hydrophilic membrane, and so forth. The waterproof breathable membrane may be made from a material such as, but not limited to, DRYVENT™, a product of The North Face® (Wilmington, Del.); GORE-TEX®, a product of W.L. Gore and Associates (Newark, Del.); DVexpedition, DValpine, and DVstorm, products of eVent® fabrics (Lee's Summit, Mo.); MemBrain®, a product of Marmot® Mountain LLC (Rohnert Park, Calif.); and SympaTex® membrane, a product of Sympatex Technologies GmbH (Unterfohring, Germany). When made of an elastic waterproof breathable material, the cover layer(s) 114, 116 may not have any slits. In another embodiment, the cover layer may have slits or perforations. The slits or perforations are formed in a resilient material, e.g., elastic material, that allows for resilient opening and closing of the slits. When in a closed configuration, the slits or perforations do not allow liquid water to leak through. The accordion action of the substrate layer will vary heat transfer properties with or without slits.

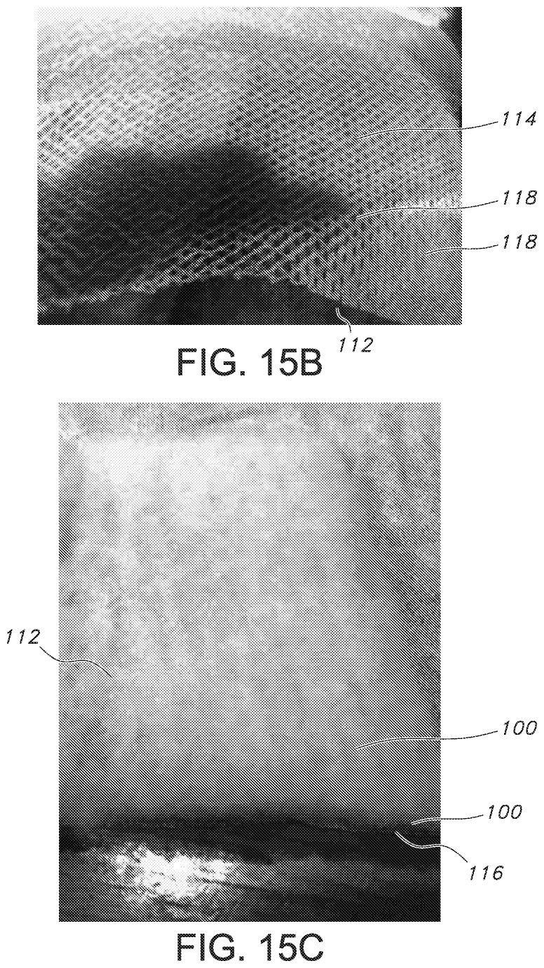

FIG. 11 shows a schematic perspective view of an exemplary method of forming the sheet of undulated substrate layer 112. The sheet has a first side 112a and an opposing second side 112b. In the illustrated method, known as “V Lap construction”, a feeder 115 feeds a continuous sheet of a pliable or drapable batt of fiber into a lapper 117. The upper portion of the lapper 117 includes a funnel. The funnel leads into a relatively narrow chamber with spaced apart parallel walls. As the sheet of bulk material passes through the funnel, it is compacted. In other words, sides 112a and 112b come closer together as the feed encounters the narrowing walls of the funnel. As the compacted sheet is fed into the relatively narrow chamber below the funnel, the sheet folds back and forth over itself, creating the undulated form shown of substrate layer 110. A belt or other conveyor receives the sheet at the opposite end of the lapper 117. The undulated form of sheet 110 may be varied by controlling the system parameters. For example, the spacing of the walls in the lapper 117 can be varied to vary the amplitude of the undulations in layer 112. The feed rate off the feeder and/or the speed of the conveyor may also be varied to affect the compactness of the undulations. The conveyor may feed the undulated substrate layer into a binder 119 that causes the fibers in the substrate layer to bind to a desired degree. For example, the binder 119 could be an oven that causes thermally fusible fibers to partially or fully melt and bond to other fibers that do not melt under the conditions in the binder. (Other methods of binding fiber are discussed elsewhere herein.) FIGS. 15A-15C are photographs showing details of layers used in a construct like that of FIG. 10.

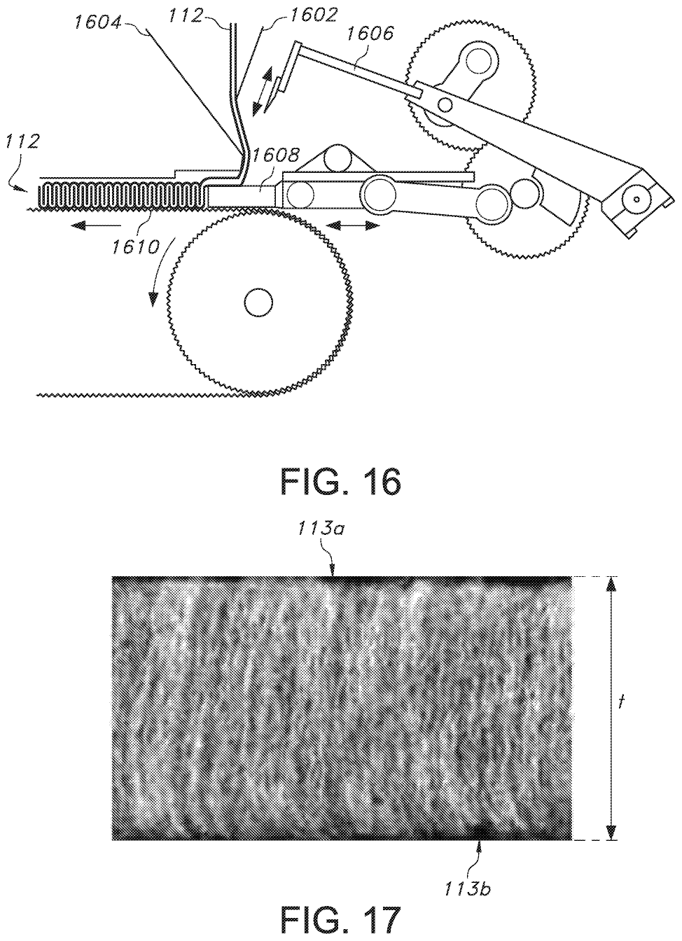

FIG. 16 shows a schematic perspective view of another exemplary method of forming the sheet of undulated substrate layer 112 before a covering layer is applied. In the illustrated method, known as “vibration vertical laying”, the batt material of substrate layer 112 is fed vertically between a cover plate 1602 and a grid 1604. A forming comb 1606 lowers into the substrate layer material to form a fold while the presser bar 1608 is retracted to the right side (not shown). The forming comb 1606 retracts upward, leaving the fold, and the presser bar 1608 pushes the folded substrate leftward as shown. The folded portion of the substrate layer 112 is moved via a conveyor 1610 away from the presser bar 1608. The now-undulated substrate layer 112 may be conveyed or otherwise transported to a binder such as the one described in FIG. 11 or to some other device or process to bind the undulations together to a desired degree (not shown).

The undulated form of sheet 110 may be varied by controlling system parameters of the apparatus shown in FIG. 16. For example, the spacing above the conveyor 1610 may affect the thickness of the sheet, while the speed of the conveyor 1610 and/or the speed of the presser bar's back-and-forth motion may affect the compactness of the undulations. The angle and/or length of the forming comb 1606 relative to the conveyor 1610 may also affect the amplitude of the undulations.

FIG. 17 is a photograph showing a cross-section of the undulated substrate layer 112 as may be formed by the method shown in FIG. 16. In various embodiments, the thickness t between the top layer 113a and the bottom layer 113b may be between about 3 to about 60 mm, for example, between 5 and 55 mm, or between 15 and 40 mm. The photograph of FIG. 17 may represent the undulated substrate layer in a relatively un-tensioned first condition. When pulled laterally into a more tensioned second condition (not shown), the undulations may be pulled or spread apart in an accordion-like manner, which may reduce the thickness t. Alternatively, or in addition, the spacing between adjacent undulations may increase, reducing the density of the layer, which may allow more air or fluid flow through the layer. Reducing the thickness and/or density of the layer 112 may increase venting and breathability while the layer is in the second condition.

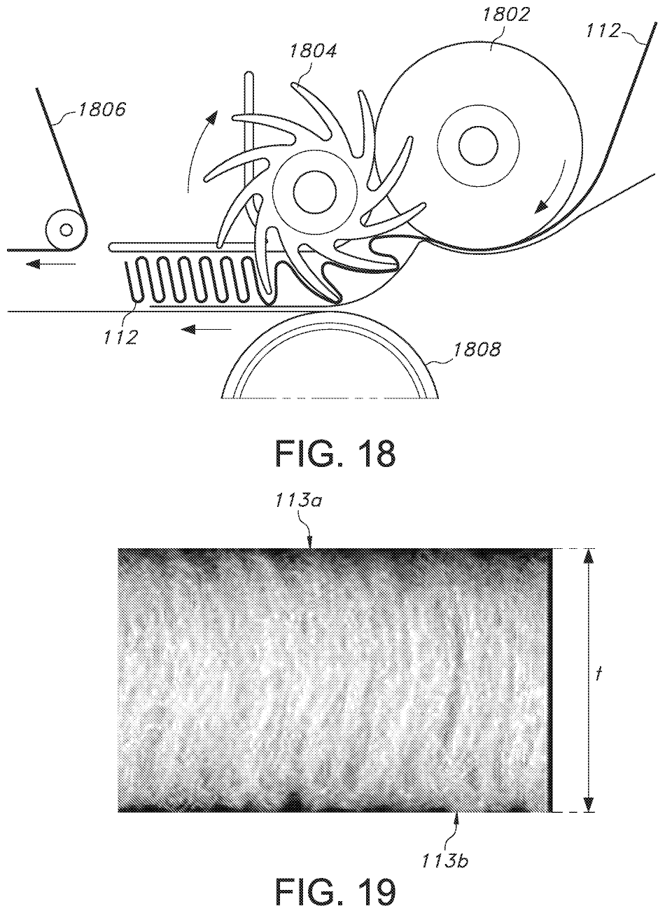

FIG. 18 shows a schematic perspective view of another exemplary method of forming the sheet of undulated substrate layer 112 before a covering layer is applied. IN the illustrated method, known as “rotational vertical laying”, the substrate layer 112 is fed vertically past a feeding disc 1802. A rotating forming comb 1804 presses fins or teeth against the substrate layer 112, folding the substrate layer. As the forming comb 1804 rotates, the fin or tooth presses the folded substrate against previously formed undulations, and in a direction away from the feeding disc 1802. The now-undulated substrate layer 112 may be conveyed along a lower conveyor belt 1808 and an upper conveyor belt 1806 or otherwise transported to a binder such as the one described in FIG. 11 or to some other device or process to bind the undulations together to a desired degree (not shown).

The undulated form of sheet 110 may be varied by controlling system parameters of the apparatus shown in FIG. 18. For example, the spacing between the lower conveyor belt 1808 and the upper conveyor belt 1806 may affect the thickness of the sheet. The speed of the conveyors 1806, 1808 and/or the speed of the feeding disc 1802 and the forming disc 1804 may affect the compactness of the undulations. The shape and/or spacing of the fins or teeth of the forming disc 1804 may also affect the amplitude and/or compactness of the undulations.

FIG. 19 is a photograph showing the undulated substrate layer 112 formed by the method shown in FIG. 18. In various embodiments, the thickness t between the top layer 113a and the bottom layer 13b may be between about 2 to about 75 mm, for example, between 3 and 55 mm, between 3 and 50 mm, between 5 and 55 mm, or between 5 and 70 mm. The photograph of FIG. 19 may represent the undulated substrate layer in a relatively un-tensioned first condition. As described regarding FIG. 17, when pulled laterally into a more tensioned second condition, the undulations may be pulled or spread apart in an accordion-like manner, which may reduce the thickness t.

According to the inventive subject, a plurality of selectively openable slits 18 may be formed in at least covering layer 14, as seen, for example, in FIGS. 1-2 and 10. The substrate layer may or may not include slits. If the substrate layer also includes slits, the slits of the adjacent layers may be aligned to facilitate direct venting and breathability from one layer to another. Or they may be offset for less direct venting and breathability. If the substrate layer does not have slits, it may have another heat dissipation mechanism, such as accordion-like undulations, as described above.

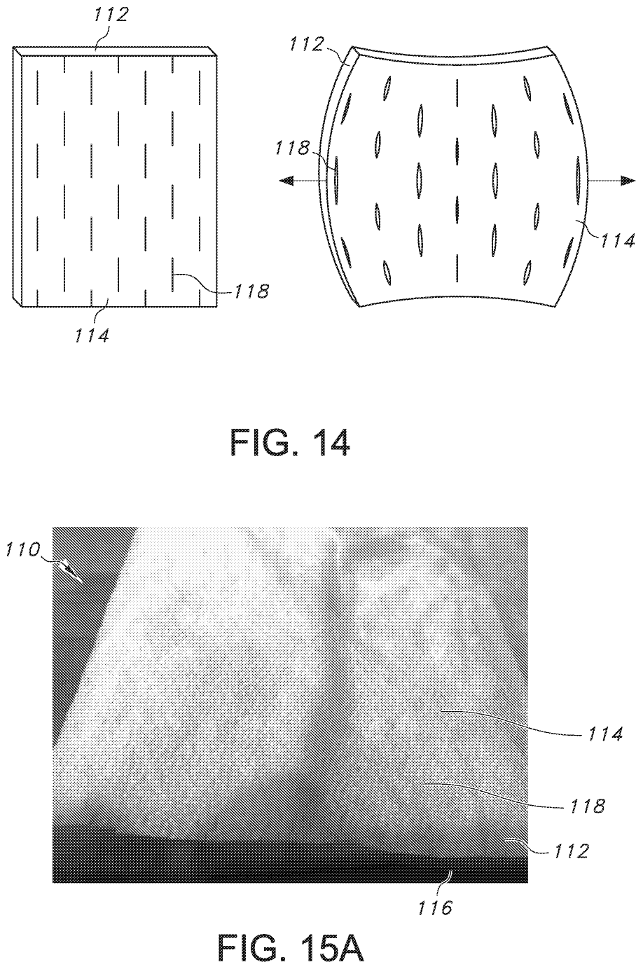

In the embodiment of FIG. 14, a plurality of selectively openable slits 118 are formed in both the substrate layer 112 and in the covering layer 114. The substrate layer may or may not include slits. The slits of the adjacent layers may be aligned to facilitate direct venting and breathability from one layer to another. Or they may be offset for less direct venting and breathability.

In alternative embodiment (not shown), just the substrate layer has selectively openable slits. The covering layer may or may not have slits. If the covering layer does not have slits, it may have another heat dissipation mechanism such as an open mesh structure or static perforations that are permanently open and do not selectively open and close.

In any embodiment contemplated under the inventive subject matter, the construct 10, 110 may have more layers that just a covering layer and a substrate layer. For example, the substrate layer may have a first covering layer disposed on a first side and a second covering layer disposed on a second side. Each covering layer may be the same material or different materials. Each covering layer may have the same or a different configuration of slits. For example, in an article of apparel or other bodywear, the body facing side may vary from the outer-facing cover layer in terms of number of slits, size and shapes of slits, density of slits per square meter, and degree of force to open slits. These same parameters may be varied in any given layer of the construct, not just in the covering layers.

Any given layer of the construct 10, 110 may also be made of multiple sublayers or plies. For example, a body facing side of the substrate layer may be made of a first sublayer that has different moisture wickability than an adjacent, outward facing sublayer. Or one sublayer may be more durable than another sublayer. The slits in any given layer of construct may have a length of between 1 mm to 2 cm in at least one dimension. The slits in any given layer of a construct may have a density of at least 10 slits per square meter. The slits in any given layer of a construct may have a density of 10,000 to 10 slits per square meter, or thereabout.

The construct 10, 110 and its components may be varied in other ways. In any of the contemplated embodiments, the covering layer may have a fabric weight of 5 to 100 grams per square meter, or thereabout. In any of the contemplated embodiments the overall construct may have a fabric weight of 10 grams to 350 grams per square meter, or thereabout. In some embodiments, the covering layer has a weight of 5 grams to 100 grams per square meter, or thereabout.

Any of the embodiments of an insulative construct 10, 110 may be embodied as a layer in an article of manufacture like an article of apparel, footwear, headwear, gloves, sleeping bag. The construct may be used in any layer of such an article. It may be the only layer in the article or it may be combined with other layers. It may be an inner layer sandwiched between other layers. It may be outward facing layer or an inward facing layer. The constructs in most applications, alone or in combination with other layers, will form some or all of a panel of an article. For example, in the case of apparel, the article can be subdivided into substantial portions mapped to coverage regions, such as a chest portion, back-of-body portion, side-of-body portion, leg portion, pelvic portion, arm portion, head portion, or other such substantial portion of the article. Any such portion can be considered a panel whether that portion represents a discrete portion that is attached to other portions or is a unitary portion that is seamlessly or otherwise merged with other portions.

The inventive subject is also directed to various possible methods of making the constructs 10, 110 and articles contemplated herein. In one possible embodiment, a method of making a construct of selectively ventable insulation, includes the steps of: providing a substrate layer comprising a cohesive, bulky web of entangled fibers, with the web material defining a first side and an opposing second side of the substrate layer, with web material therebetween having an undulated form based on lapping of the web material; providing a covering layer disposed adjacent to and coextensively over the first side of the substrate layer, a plurality of slits formed in the covering layer, assembling the covering layer adjacent to and coextensively over the first side of the substrate layer. In the method, the covering layer is assembled and configured so that when it is in a first condition, the slits are closed, and when in a relatively tensioned second condition, the slits become open perforations through the covering layer, thereby allowing venting of air or other fluid from a side of the covering layer that is adjacent the first side of the substrate layer.

In another possible embodiment, a method of making a construct of selectively ventable insulation, includes the steps of: providing a substrate layer comprising a cohesive, bulky web of entangled fibers, with the web material defining a first side and an opposing second side of the substrate layer a plurality of slits being formed in the substrate layer, providing a covering layer, assembling the covering layer adjacent to and coextensively over the first side of the substrate layer. In the method, the substrate layer is assembled and configured so that when it is in a first condition the slits are closed, and when in a relatively tensioned second condition, the slits become open perforations through the substrate layer, thereby allowing venting of air or other fluid from the first side of the substrate layer to its second side.

The methods may include a method of assembling or otherwise using a construct according to the inventive subject with other components of an article of manufacture like an article of apparel, footwear, headwear, gloves, or sleeping bag. In one possible method, the construct is assembled into an article by sandwiching it between other layers so that the construct becomes comprises an interlayer layer in the article. In another method, construct is selectively mapped to and assembled into an area of the article that needs relatively more venting or breathability than an adjacent area.

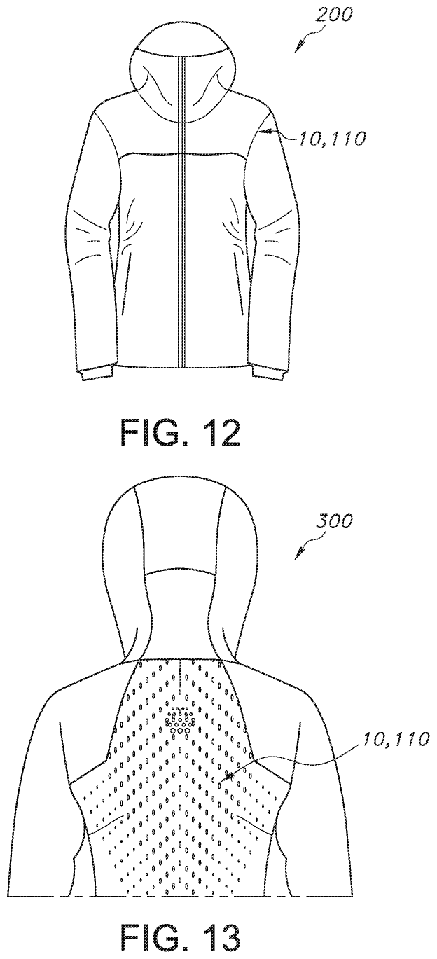

FIGS. 12-13 show representative articles 200, 300 that incorporate a construct according to the inventive subject matter. The articles shown are jackets and the constructs are interlayers. The dotted areas represent areas where there are constructs. The jackets generally would have an outer layer and a liner sandwiching the constructs. The jackets may also include a waterproof breathable membrane layer. In the jacket of FIG. 12, the construct may be incorporated at some or all of the front side of the jacket. In the embodiment of FIG. 13, an inventive construct is incorporated in a back portion of the garment. The construct may extend under the underarms.

Any patent and non-patent literature cited herein is hereby incorporated by references in its entirety for all purposes.

The principles described above about any particular example can be combined with the principles described regarding any one or more of the other examples. The previous description of the disclosed embodiments is provided to enable any person skilled in the art to make or use the disclosed innovations. Various modifications to those embodiments will be readily apparent to those skilled in the art, and the generic principles defined herein may be applied to other embodiments without departing from the spirit or scope of this disclosure. Thus, the claimed inventions are not intended to be limited to the embodiments shown herein, but are to be accorded the full scope consistent with the language of the claims, wherein reference to an element in the singular, such as by use of the article “a” or “an” is not intended to mean “one and only one” unless specifically so stated, but rather “one or more”. As used herein, “and/or” means “and” or “or”, as well as “and” and “or.”

All structural and functional equivalents to the elements of the various embodiments described throughout the disclosure that are known or later come to be known to those of ordinary skill in the art are intended to be encompassed by the features described and claimed herein. Moreover, nothing disclosed herein is intended to be dedicated to the public regardless of whether such disclosure is explicitly recited in the claims. No claim element is to be construed as “a means plus function” claim under US patent law, unless the element is expressly recited using the phrase “means for” or “step for”.

The inventor(s) reserves the right to claim, without limitation, at least the following subject matter.

1. A construct of selectively ventable insulation, comprising:
the substrate layer comprising a cohesive, bulky web of entangled fibers, with the web material defining a first side and an opposing second side of the substrate layer, with web material therebetween having an undulated form based on lapping of the web material; and
a covering layer disposed adjacent to and coextensively over the first side of the substrate layer, a plurality of slits formed in the covering layer, the covering layer being configured so that when it is in a first condition the slits are closed, and when in a relatively tensioned second condition, the slits become open perforations through the covering layer thereby allowing venting of air or other fluid from a side of the covering layer that is adjacent the first side of the substrate layer.

2. The construct of claim 1 further comprising a plurality of slits formed in the substrate layer, the substrate layer being configured so that when it is in a first condition the slits are closed, and when in a relatively tensioned second condition, the slits become open perforations through the substrate layer, thereby allowing venting of air or other fluid from the first side of the substrate layer to its second side.

3. (canceled)

4. A construct of selectively ventable insulation, comprising:
a substrate layer comprising a cohesive, bulky web of entangled fibers, with the web material defining a first side and an opposing second side of the substrate layer;
a covering layer disposed adjacent to and coextensively over the first side of the substrate layer, wherein the covering layer is configured with a plurality of slits such that when the covering layer is in a first condition, the slits are closed, and when in a relatively tensioned second condition, the slits become open perforations through the covering layer thereby allowing venting of air or other fluid from a side of the covering layer that is adjacent the first side of the substrate layer; and
a plurality of slits formed in the substrate layer, the substrate layer being configured so that when it is in a first condition the slits are closed, and when in a relatively tensioned second condition, the slits become open perforations through the substrate layer, thereby allowing venting of air or other fluid from the first side of the substrate layer to its second side.

5.-6. (canceled)

7. The construct of claim 1 wherein the slits have a length of between 1 mm to 2 cm in at least one dimension, or thereabout.

8. (canceled)

9. The construct of claim 1, wherein the covering layer and/or the substrate layer has a density of 10 to 10,000 slits per square meter, or thereabout.

10.-11. (canceled)

12. The construct of claim 29, wherein the construct has a fabric weight of at least 100 grams per square meter, or thereabout.

13. (canceled)

14. The construct of claim 29 wherein the covering layer comprises a nonwoven, drapable material in the nature of a scrim.

15. (canceled)

16. The construct of claim 1 further comprising a second covering layer disposed adjacent to and coextensively over the second side of the substrate layer.

17. The construct of claim 16 wherein the second covering layer is configured with a plurality of slits such that when the second covering layer is in a first condition, the slits are closed, and when in a relatively tensioned second condition, the slits become open perforations through the covering layer thereby allowing venting of air or other fluid from a side of the covering layer that is adjacent the second side of the substrate layer.

18.-19. (canceled)

20. An article of apparel, footwear, headwear, gloves, sleeping bag having a panel comprising a construct of claim 29.

21. A method of making a construct of selectively ventable insulation, comprising:
providing a substrate layer comprising a cohesive, bulky web of entangled fibers, with the web material defining a first side and an opposing second side of the substrate layer, with web material therebetween having an undulated form based on lapping of the web material;
providing a covering layer disposed adjacent to and coextensively over the first side of the substrate layer, a plurality of slits formed in the covering layer;
assembling the covering layer adjacent to and coextensively over the first side of the substrate layer; and
wherein the substrate layer being configured so that when it is in a first condition the undulations have a first thickness between the first side and the opposing second side, and when in a relatively tensioned second condition, the undulations spread apart to a second thickness less than the first thickness, thereby allowing venting of air or other fluid therethrough.

22. The method of claim 21, wherein providing a substrate layer comprises undulating the web material by one of: vibration vertical laying; rotational vertical laying; or V-lap construction

23. (canceled)

24. The method of claim 21 further comprising making an article of apparel, footwear, headwear, gloves, or sleeping bag having a panel portion by assembling the construct with one or more other portions of the article to form a panel portion of the article.

25. (canceled)

26. The article of any of claim 20 wherein the construct is selectively mapped to an area of the article that needs relatively more venting or breathability than an adjacent area.

27. The construct of claim 29 wherein at least one layer of the construct is elastic.

28. (canceled)

29. A construct of selectively ventable insulation, comprising:
the substrate layer comprising a cohesive, bulky web of entangled fibers, with the web material defining a first side and an opposing second side of the substrate layer, with web material therebetween having an undulated form based on lapping of the web material, the substrate layer being configured so that when it is in a first condition the undulations have a first thickness between the first side and the opposing second side, and when in a relatively tensioned second condition, the undulations spread apart to a second thickness less than the first thickness, thereby allowing venting of air or other fluid therethrough; and
a covering layer disposed adjacent to and coextensively over the first side of the substrate layer.

30. The construct of claim 29, wherein the covering layer is a waterproof breathable covering layer.

31. The construct of claim 29, wherein the covering layer is an elastic covering layer.

32. The construct of claim 29, wherein the elastic covering layer comprises a plurality of slits formed in the covering layer, the covering layer being configured so that when it is in a first condition the slits are closed, and when in a relatively tensioned second condition, the slits become open perforations through the covering layer thereby allowing venting of air or other fluid from a side of the covering layer that is adjacent the first side of the substrate layer.
